(19) United States
(12) Patent Application Publication
(10) Pub. No.: US 2021/0175485 A1
(43) Pub. Date: Jun. 10, 2021

(54) SYSTEM AND METHOD FOR OPERATING A DUAL BATTERY SYSTEM

(71) Applicant: A123 Systems LLC, Waltham, MA (US)

(72) Inventors: Jeffrey T. Sieber, Livonia, MI (US); Sean Bartolucci, Canton, MI (US); Samuel L. Trinch, Waltham, MI (US)

(21) Appl. No.: 16/714,630

(22) PCT Filed: Jun. 4, 2018
(86) PCT No.: PCT/US2018/035899

§ 371 Date: Dec. 13, 2019

Related U.S. Application Data
(60) Provisional application No. 62/520,468, filed on Jun. 15, 2017.

(51) Int. Cl. H01M 2/26; H01M 2/14; H01M 2/12; H01M 10/44; H01M 10/615

(52) U.S. Cl. CPC H01M 2/263; H01M 2/14; H01M 10/615; H01M 10/443; H01M 2/1264

(57) ABSTRACT

A method for a battery system may include applying a charge voltage to a first battery and a second battery electrically connected in parallel, diverting a portion of the charge voltage in excess of a threshold voltage from all battery cells of the second battery to a heater coupled externally to the second battery, and transferring heat from the heater to the second battery, the heat generated from the portion of the charge voltage. In this way, degradation of the second battery can be reduced during battery charging, especially at colder temperatures.

### CROSS REFERENCE TO RELATED APPLICATIONS

The present application claims priority to U.S. Provisional Application No. 62/520,468, entitled “SYSTEM AND METHOD FOR OPERATING A DUAL BATTERY SYSTEM”, and filed on Jun. 15, 2017. The entire contents of the above-listed application are hereby incorporated by reference for all purposes.

### TECHNICAL FIELD

The present description relates to methods and systems related to a dual battery system.

### BACKGROUND AND SUMMARY

Auxiliary (Aux) dual battery systems can provide cost effective designs for battery applications where both long term and short term energy storage and dissipation are desirable. For example, in a hybrid vehicle a low-cost, traditional lead acid battery may be coupled with a small, high power lithium ion battery. Whereas the lead acid battery is utilized primarily for engine cranking, the smaller lithium ion battery allows for higher power for charge recuperation during regenerative braking and discharge power for cold cranking.

However, the inventors herein have recognized potential disadvantages with the above approach. The charge voltage of lead acid batteries increases as temperature decreases, and is higher than the charge voltage of certain configurations of lithium ion batteries at low temperatures. Applying these high charge voltages to the lithium ion batteries can degrade the lithium ion battery, for example, because of lithium metal plating at the battery electrodes. Some conventional dual battery systems utilize a lithium titanate (LTO) battery coupled with a lead acid battery because LTO batteries can be more tolerant to plating at cold temperatures as compared with other lithium ion battery types. However, LTO batteries are more costly to produce, and are less compact than other types of lithium batteries, which can raise manufacturing costs.

One approach that at least partly addresses the above issues includes a battery system comprising: a first battery and a second battery electrically connected in parallel, the second battery comprising a plurality of battery cells and a heater thermally coupled to the plurality of battery cells; and a controller on board the second battery, including executable instructions to, in response to a charge voltage being greater than a threshold voltage, diverting a portion of the charge voltage in excess of a threshold voltage from the second battery to the heater.

By diverting voltage from the second battery to a heater thermally coupled to one or more battery cells of the second battery, degradation of the second battery due to high charge voltages can be reduced. Furthermore, diverting voltage to the heater can aid in increasing the temperature of the second battery, further reducing degradation of the second battery. Further still, reducing degradation of the second battery, including at colder temperatures, facilitates utilizing lower-cost higher-density lithium battery chemistries, such as lithium iron phosphate (LFP), the dual battery system.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic view of an exemplary assembly of a battery cell stack;

FIG. 2 shows a schematic view of an exemplary battery cell;

FIG. 3 shows a simplified schematic diagram of an exemplary dual battery system;

FIG. 4 shows a plot of battery charging profiles;

FIG. 5 shows a partial schematic view of the battery system of FIG. 3 including an external heater

FIG. 6 shows an example schematic of a voltage detection and control system;

FIG. 7 shows an example flow chart for a method of operating the battery system of FIG. 3 including the battery system of FIG. 5.

FIG. 8 shows an example timeline for operating the battery system of FIG. 3 including the battery system of FIG. 5.

### DETAILED DESCRIPTION

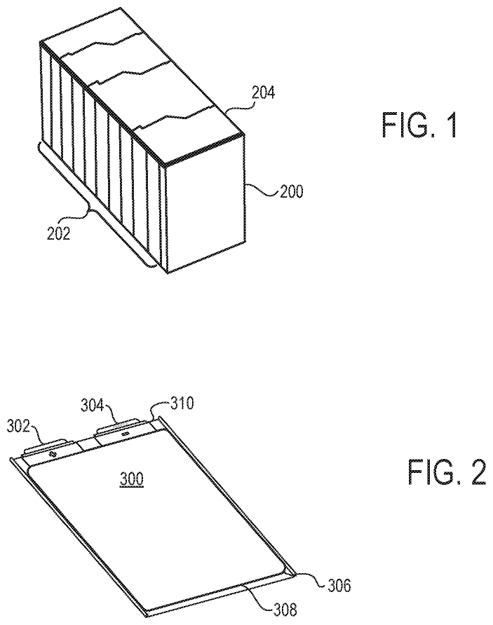

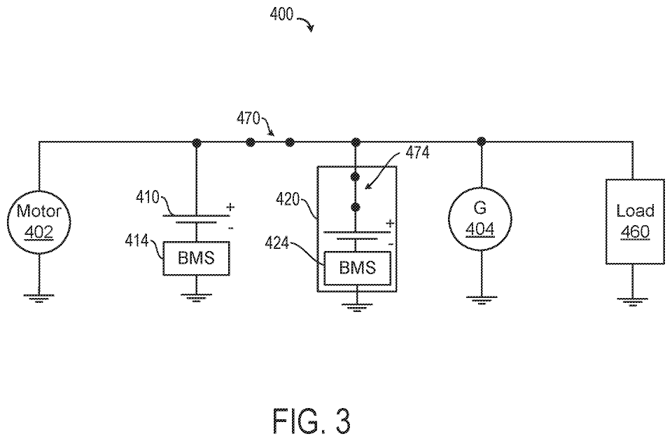

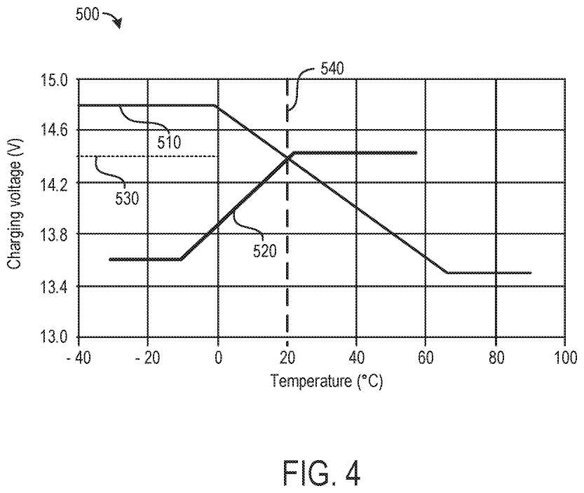

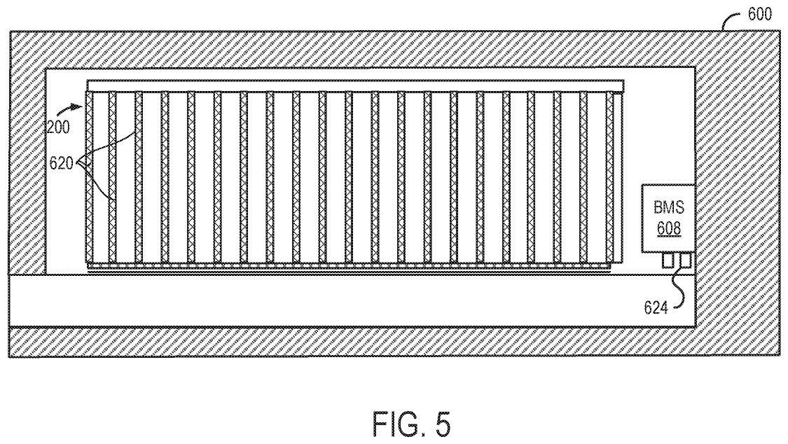

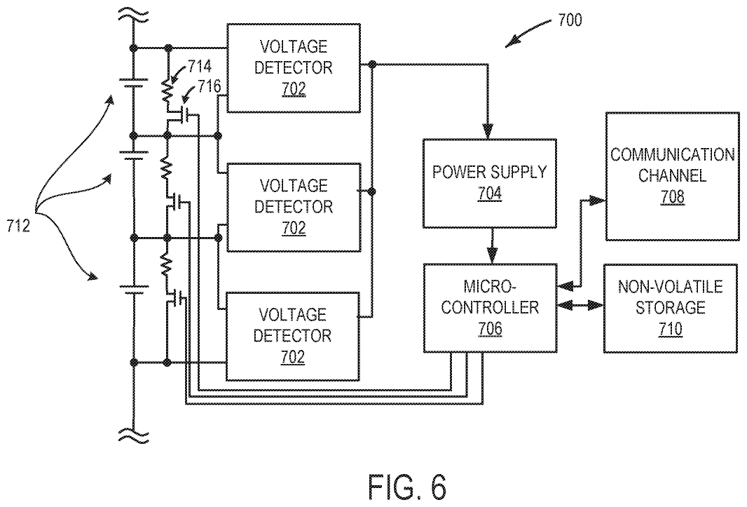

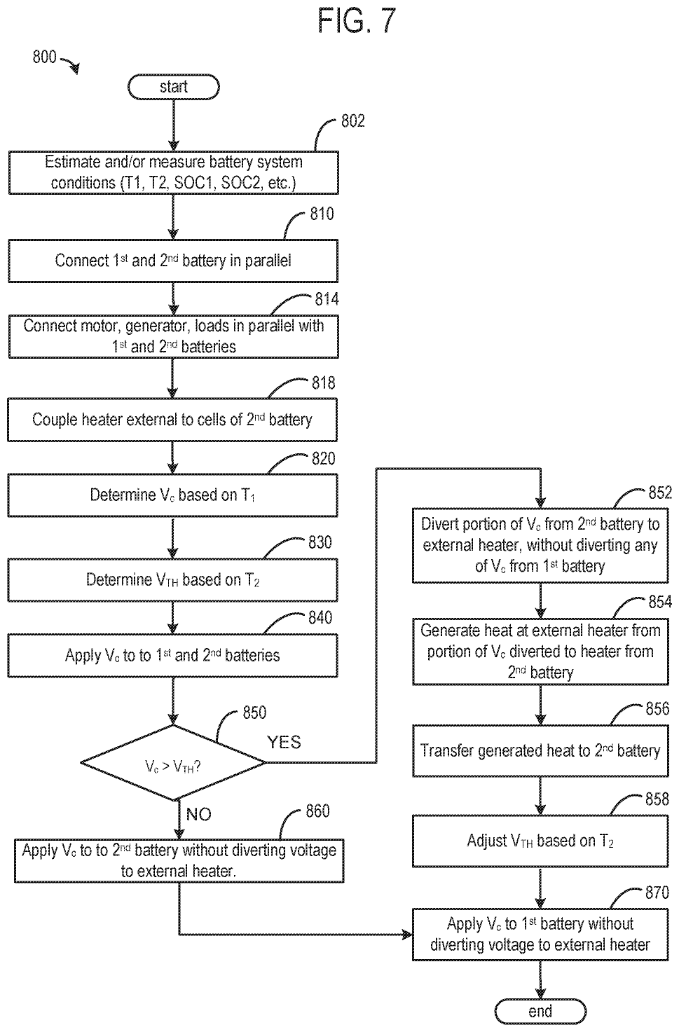

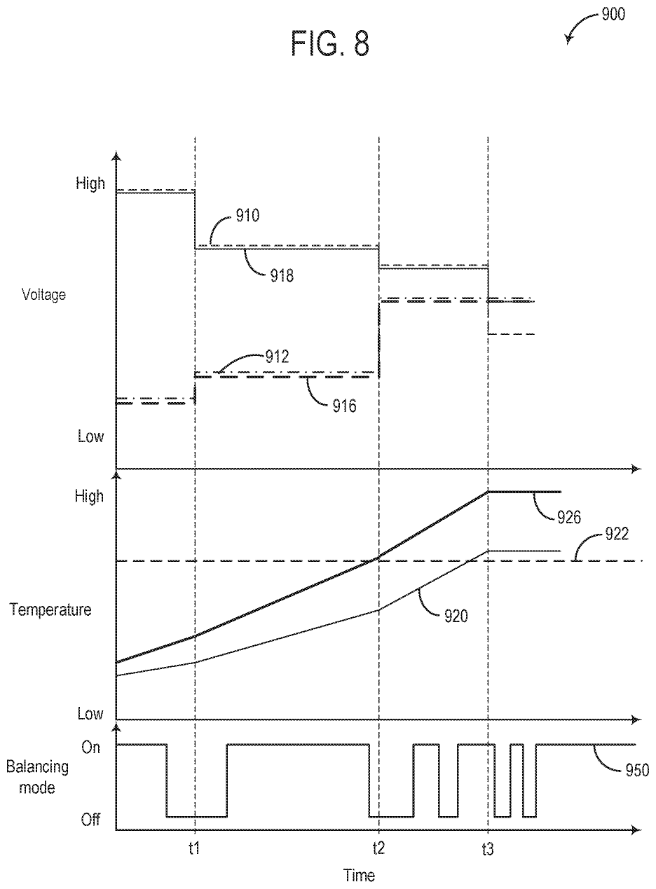

The present description is related to methods and systems for a dual battery system, including a first battery electrically coupled to a second battery, as shown in FIG. 3. In one embodiment, the battery pack of the second battery may be comprised of one or more battery cell stacks, one of which is illustrated in FIG. 1, and the battery cell stacks may be comprised of a plurality of battery cells, one of which is illustrated in FIG. 2. The second battery may further include a voltage detection and control system, as shown in FIG. 6. As shown in FIG. 4, the first battery and the second battery may exhibit distinct charging profiles with respect to temperature. By adding a heater external and adjacent to the battery cells of the second battery as shown in FIG. 5, and by diverting higher charge voltages from the second battery to the heater, degradation of the second battery can be reduced. A method and timeline for operating the dual battery system of FIG. 3 is illustrated in FIGS. 7 and 8, respectively.

Referring now to FIG. 1, an exemplary assembly of a battery cell stack 200 is shown. Battery cell stack 200 is comprised of a plurality of battery cells 202. In some embodiments, the battery cells may be lithium-ion battery cells such as (lithium iron phosphate) LFP or (lithium titanate) LTO battery cells, for example. In the example of FIG. 1, battery cell stack 200 is comprised of ten battery cells 202. Although battery cell stack 200 is depicted as having ten battery cells 202, it should be understood that a battery cell stack 200 may include more or less than ten battery cells. For example, the number of cells in a battery cell stack 200 may be based on an amount of power desired from the battery cell stack 200. Within a battery cell stack 200, battery cells 202 may be coupled in series to increase the battery cell stack voltage, or battery cells 202 may be coupled in parallel to increase current capacity at a particular battery voltage. Further, a battery pack may be comprised of one or more battery cell stacks 200. As shown in FIG. 1, battery cell stack 200 further includes cover 204 which provides protection for battery interconnects (not shown) that route charge from the plurality of battery cells 202 to output terminals of a battery pack.

Turning now to FIG. 2, an exemplary embodiment of an individual battery cell 300 is shown. Battery cells 202 may be represented by the battery cell 300 in FIG. 2. Battery cell 300 includes cathode 302 and anode 304 for connecting to a bus (not shown). The bus routes charge from a plurality of battery plates to output terminals of a battery pack and may be coupled to bus bar support 310. Battery cell 300 further includes prismatic cell 308 that contains electrolytic compounds. Prismatic cell 308 is in communication with heat sink 306. Heat sink 306 may be formed of a metal plate with the edges bent up 90 degrees on one or more sides to form a flanged edge. In the example of FIG. 2, the bottom edge, and sides, each include a flanged edge.

When a plurality of cells is put into a stack, the Prismatic cells may be separated by a compliant pad (not shown). Thus, a battery cell stack is built in the order of heat sink, Prismatic cell, compliant pad, Prismatic cell, heat sink, and so on. One side of the heat sinks (e.g., flanged edges) may then contact the cold plate to increase heat transfer. In some embodiments, the compliant pads separating the Prismatic cells may include heating coils or heating pads for transferring heat to the battery cells 300 (see FIG. 5).

Referring now to FIG. 3, it illustrates a simplified schematic of a dual battery system 400, comprising a first battery 410 and a second (auxiliary) battery 420. In one example embodiment, the dual battery system 400 may comprise a lead acid battery as the first battery 410 and a lithium ion battery (such as an LTO or LFP battery) as the second battery 420. The second battery 420 may comprise one or more battery packs 200 including one or more battery cell stacks 200 as described with reference to FIGS. 1 and 2 above. In the dual battery system of FIG. 3, the first battery and the second battery are electrically coupled in parallel to each other and to one or more power sources 404, one or more loads 460, and a motor 402.

Power source 404 may comprise one or more power sources such as an alternator coupled to an internal combustion engine and a motor coupled to a regenerative braking system. The power source 404 may be used to charge one or both of the first battery and the second battery. The charging of one or both of the first battery and the second battery by the power source 404 may be dependent on the type of power generated by the power source 404. In some examples, the one or more power sources 404 may be used to charge one or both of the first battery 410 and the second battery 420. For example, an alternator may be used to charge both the first battery 410 and the second battery 420, whereas a motor driven by a regenerative braking system may be used to charge the second battery 420. For example, if the power source 404 comprises a flywheel generating power from regenerative braking in a vehicle, power from power source 404 may primarily charge the second battery (e.g., a lithium ion battery) since the charging rates are higher. In another example, the motor 402 may drive a power source 404 such as an alternator, which can be used to more slowly charge the first battery 410 (e.g., a PbA type battery).

One or both of the first battery 410 and the second battery 420 may provide power to the one or more loads 460, depending on the power discharge rate. Loads 460 requiring higher discharge rates, for example a motor powering propulsion of vehicle, may be provided primarily by the second battery 420, whereas loads 460 requiring lower discharge rates may be powered primarily by the first battery 410. The dual battery system 400 may reside on board a vehicle for powering loads 460 such as auxiliary loads such as vehicle lights, HVAC, audio/visual accessories, vehicle seat positioners, seat warmers, and the like.

Dual battery system may comprise one or more battery management systems 414 and 424. As shown in FIG. 3, a battery control module or battery management system (BMS) 414 may be electrically connected proximally to the first battery 410 and may aid in regulating or measuring voltage and/or current supplied to and dissipated from the first battery 410. In some examples, the first battery 410 may not include a BMS. In other examples, first battery 410 may include an intelligent battery sensor (IBS). BMS 424 may reside on board the second battery 420, as illustrated in the example of FIG. 5, and may control modules for regulating voltage and/or current supplied to and dissipated from individual battery cells 202 in the battery cell stack 200 of the second battery 420. In other embodiments, BMS 414 and BMS 424 may be integrated into a single BMS for regulating voltage and/or current supplied to and dissipated from both first battery 410 and second battery 420. Further, the BMS may be comprised of a microprocessor having random access memory, read only memory, input ports, real time clock, and output ports. Various sensors such as temperature sensors may communicate internal environmental conditions of battery pack 200 to BMS 424. The BMS may further aid in regulating voltage and/or current supplied to and dissipated from the battery cell stack 200. For example, during charging of the battery pack 200, the BMS may regulate voltage levels to each individual battery cell in the battery cell stack 200 to balance the charging of each battery cell and to reduce overcharging of the battery cells, which can cause degradation of the battery cell stack.

Dual battery system may further include various sensors, such as temperature sensors 624, as described above with reference to FIG. 5, which can transmit signals to the one or more BMSs 414 and 424. Various switches and/or relays may include a cranking disconnect 470. In one example, cranking disconnect may be used for decoupling a motor 402 such as a starting motor from an engine after an engine has been started. A switch or relay 474 may be used to decouple the second battery 420 from a power source 404, for example, when a charge voltage is greater than a threshold voltage, to reduce a risk of degrading the second battery 420.

Referring now to FIG. 4, it illustrates example plot 500 showing charging profiles 510 and 520 versus temperature for a lead acid (PbA) battery and a lithium iron phosphate (LFP) battery, respectively. As shown by the lead acid battery charging profile 510, at lower temperatures the charge voltage for the lead acid battery is high and greater than a cold temperature lithium plating voltage 530. In the example plot 500, the cold temperature lithium plating voltage 530 is approximately 14.4 V below 0° C. Furthermore, the charge voltage of the lead acid battery does not decrease below the cold temperature lithium plating voltage until the temperature increases above a threshold temperature 540 (e.g., approximately 20° C.). As such, at temperatures less than 20° C., charging a dual battery system comprising a lead acid battery and a LFP battery coupled in parallel can lead to lithium plating and degradation of the LFP battery since the charge voltage applied to the dual batteries is given by the charge profile of the PbA battery.

As the temperature is increased, the charge voltage of the PbA battery tends to decrease, whereas the charge voltage of the LFP battery tends to increase. Accordingly, heating the dual battery system, in particular heating the LFP battery, can reduce a risk of degradation of the second battery, and also increase charging performance since the charging of the LFP battery can be performed at higher charge voltages (but still less than the cold temperature lithium plating voltage 530). At temperatures above 20° C., the charge voltage for the PbA battery is less than the lithium plating voltage, and the heater may not be utilized.

Referring now to FIG. 5, it illustrates an example battery pack 600 including one or more heaters 620 positioned intercellularly between each battery cell in the battery cell stack 200, and at the ends of the battery cell stack 200. The heaters may be positioned adjacent and external to the battery cells, and apart from the electrolyte within the battery cells. In this way, existing battery pack designs can be retrofitted easily with the heaters 620. For example existing compression pads or compliant pads between the battery cells can be replaced or outfitted/augmented with heaters 620. In one embodiment, battery pack 600 can be an LFP battery pack, wherein the heaters 620 are used to heat LFP battery cells in the LFP battery cell stack. Heaters 620 may comprise flat sheet compression pad type heaters, resistance heaters, or another type of compact heater that can efficiently and uniformly transfer heat to the battery cells. Heaters 620 may be electrically coupled to the BMS 608. Furthermore, although not shown, battery pack 600 may further include one or more temperature sensors 624 and one or more voltage sensors (see FIG. 6) to measure and/or imply the temperature and voltage of each battery cell of battery cell stack 200, respectively. In this way, the temperature of and voltage applied to each of the battery cells can be determined and communicated to BMS 608.

Furthermore, the BMS 608 can direct voltage and/or current to one or more of the battery cells in battery cell stack 200 responsive to the one or more temperature and voltages at the battery cells. For example, in response to a charge voltage being greater than a threshold voltage, the BMS may divert a portion of the charge voltage in excess of the threshold voltage from the battery cells of battery cell stack 200 to the one or more heaters 620 adjacent and external thereto. The threshold voltage may correspond to an electrode plating voltage, such as cold temperature lithium plating voltage 530. As such, diverting the portion of the charge voltage in excess of the threshold voltage may reduce a risk of degradation of the dual battery system. In another example, the threshold voltage may vary with temperature and state of charge, and can be determined based on a charge voltage profile 520 for the battery and a temperature of the battery. Diverting excess voltage from the battery to one or more heaters 620 generates heat at the heater 620, thereby increasing the battery cell temperature. In the case of charge voltage profile 520, increasing the battery temperature can increase the threshold voltage. A higher threshold voltage raises the effective charge voltage of the battery (since only voltage excess to the threshold voltage is diverted), thereby reducing a risk of degradation and increasing a charging power.

Referring now to FIG. 6, a schematic diagram of a voltage detection and management system 700 is shown. The voltage detection and management system 700 may reside within a battery, such as the battery 420 as shown in FIG. 3, or the battery pack 600 as shown in FIG. 5, and reside on board the BMS. As depicted, the system includes a plurality of battery cells 712, voltage detectors 702, charge reducing circuitry for each battery cell, a power supply 704, non-volatile storage 710, and a microcontroller 706 that is in communication with a BMS by way of communication channel 708. Power supply 704 may be activated by voltage detectors or by the BMS. In some examples, one or more of the voltage detectors 702, power supply 704, micro-controller 706, non-volatile storage 710, and communication channel 708 may be integrated into the BMS.

In the example of FIG. 6, each of the plurality of battery cells 712 is shown in communication with a voltage detector 702 which includes voltage detection circuitry. Voltage detector circuits 702, power supply 704, microcontroller 706, non-volatile storage 710, load resistor 714, transistor switch 716, and communication channel 708 are incorporated into the BMS. Once the BMS is coupled to the battery cell stack 200, the battery cells are continuously monitored by the voltage detector circuits. The voltage detector circuitry may be powered by the battery cells in the battery cell stack. Thus, the battery cell stack may become self-regulating during some conditions. In one embodiment, voltage detector circuitry 702 may be comprised of a comparator referenced to a threshold balancing voltage. If the input to the comparator exceeds the threshold balancing voltage the comparator changes state from a low voltage output to a higher voltage output. The higher voltage output provides an indication that the particular battery cell is charged to a level greater than a desired level. Further, the outputs of the voltage detection circuits may be tied together in an OR arrangement so that a high level signal is present at a power supply located on the BMS whenever one of the plurality of battery cells is greater than a threshold balancing level.

When a particular battery cell voltage or voltage range is detected, voltage detector circuitry 702 outputs a high level signal to power supply 704. For example, if the voltage of an individual battery cell is greater than a threshold balancing value, voltage detector circuitry 702 may send a signal to power supply 704, thereby activating the power supply. Power supply 704 is in communication with microcontroller 706. As such, microcontroller 706 may be activated once power supply 704 is turned on. Microcontroller 706 may include digital inputs and outputs as well as one or more A/D inputs, read only memory, random access memory, and non-volatile storage.

As shown in FIG. 6, the microcontroller 706 provides a communication channel 708 for the battery pack. In one embodiment, communication channel 708 may be a CAN link. The battery pack controller may be a battery control module (BMS), as described above with reference to FIG. 3, for example. Via the communication channel 708, microcontroller 706 may communicate a variety of information. As one example, the microcontroller 706 may update the BMS regarding battery cells that have been discharged while the BMS is unavailable.

Microcontroller 706 may include non-volatile storage 710. As such, microcontroller 706 may save data regarding the plurality of battery cells to the non-volatile storage 710. For example, non-volatile storage 710 may save data regarding the voltage states of the battery cells including data regarding charge draining from the one or more battery cells that exceed the threshold voltage (e.g., amount of charge drained, number of times charge is drained from a particular battery cell, time and date of battery cell discharge etc.). In this manner, the microcontroller 706 may communicate battery cell information to the BMS when conditions are more favorable.

Once activated, microcontroller 706 may output a signal to turn on battery cell charge reducing circuitry which includes a load resistor 714 and a switch 716. For example, a digital output from the microcontroller 706 may close switch 716. As an example, switch 716 may be a transistor such as a field-effect transistor. Thus, when the switch 716 is closed, current may be allowed to flow through the charge reducing circuit. Battery cell charge may be dissipated by load resistor 714. In the example of FIG. 6, each battery cell of the plurality of battery cells is coupled in parallel with a switch (e.g., each battery cell is in communication with a switch). Once the charge of a particular battery cell is less than a threshold level, the output of voltage detector 702 coupled to the battery cell changes state to indicate that the charge of the particular battery cell is less than the desired level.

The appropriate switch (e.g., switch 716) may be set to an open condition by microcontroller 706 when battery cell voltage as measured by an A/D convertor and input to microcontroller 706 is less than the desired threshold voltage. Further, power supply 704 may be latched in an on condition by an output from the microcontroller (e.g., microcontroller 706). The microcontroller may hold a digital output high to keep the power supply activated until charge of each battery cell in the battery cell stack 200 is less than a threshold. Further, the microcontroller may keep the power supply activated until it has completed a scheduled task that was initiated by activating power supply 704 (e.g., after writing battery cell event data to non-volatile storage).

The voltage detection and management system 700 may be utilized to balance or redistribute charges and mitigate overcharging amongst individual battery cells within a battery stack during battery charging. Typically, the individual cells in a battery have somewhat different capacities and may be at different levels of state of charge (SOC). Without redistribution, discharging stops when the cell with the lowest capacity is empty (even though other cells are still not empty); this limits the energy that can be taken from and returned to the battery. Without balancing, the battery cell having the lowest capacity becomes limiting to other battery cells; it can be easily overcharged or over-discharged while cells with higher capacity undergo only partial cycle. Balancing charges bypasses the lower capacity battery cells; so that in a balanced battery, the cell with the larger capacities can be more fully charged while reducing overcharging any smaller capacity battery cells; conversely, in a balanced battery, battery cells with larger capacities can be more fully discharged while reducing over-discharging any smaller capacity battery cells. Battery balancing (e.g., a balancing mode) comprises transferring voltage (exceeding the threshold balancing voltage) from or to individual cells, until the SOC of the cell with the lowest capacity is equal to the battery's SOC.

Turning now to FIG. 7, it illustrates a method 800 of operating a dual battery system 400 including a first battery 410 and a second battery 420 (such as battery pack 600). In one embodiment, the first battery 410 may comprise a lead acid battery and the second battery 420 may comprise a lithium ion battery such as an LTO or LFP battery. Method 800 may comprise executable instructions on board a controller such as BMS 608. In other examples, method 800 may comprise executable instructions on board a controller external to the second battery 420, but electrically coupled to the dual battery system 400. Method 800 may be executed independently from a balancing mode, the balancing mode comprising when a voltage detection and management system 700 is balancing charges amongst individual battery cells as described above with reference to FIG. 6. Thus method 800 may be executed while a balancing mode is active or while a balancing mode is inactive.

Method 800 begins at 802 where battery system conditions such as temperatures of the first and second batteries (T₁, T₂), state of charge of the first and second batteries (SOC₁, SOC₂), and the like are estimated and/or measured. As described above, T₁ and T₂ may be measured using one or more temperature sensors positioned external to the battery cells but mechanically coupled to the battery cells. In other embodiments, the T₁ and/or T₂ may be inferred using one or more temperature sensors. Method 800 continues at 810, where the controller connects the first and second batteries in parallel. As described above with reference to FIG. 3 and FIG. 6, the battery system may comprise various circuitry components such as switches, transistors, and the like, which can be actuated by the controller to electrically couple the first and second batteries in parallel. At 814, the controller may similarly actuate various connect circuitry components such as switches, transistors, and the like, to connect one or more motors, generators, and loads in parallel with the first and second batteries.

Next, method 800 continues at 818 where one or more heaters external to the cells of the second battery are coupled to the cells of the second battery 818. Coupling the one or more heaters external to the cells of the second battery may comprise positioning the one or more heaters adjacent and external to the battery cells of the second battery, but within the 2^{nd} battery pack. In this way, heat that is generated at the external heaters can be more efficiently and more rapidly transferred to the battery cells of the second battery. Furthermore, by positioning the one or more heaters adjacent and external to the battery cells, existing battery packs can be retrofitted with the external heaters inexpensively, as compared to installing heaters internal (intracellularly) to the battery cells.

Method 800 continues at 820 where the controller determines a charge voltage, V_{c}, based on the temperature of the first battery, T₁. In one example, T₁ may be determined from a charge voltage profile 510, a lookup table, and the like. In this way, V_{c} may be temperature dependent. At 830, the controller may determine a threshold voltage, V_{TH}, based on a temperature of the second battery, T₂. T₂ may be determined from a battery charge voltage profile 520 of the second battery, a lookup table and the like. In this way, the threshold voltage, V_{TH}, for the second battery may be temperature dependent and may correspond to the charge profile for the second battery. In another example, V_{TH} may correspond to a voltage above which the rate of battery degradation is increased. For example, V_{TH} may correspond approximately to the cold temperature plating voltage of −14.4 V for a LFP battery.

At 850, the controller determines if a first condition is met. The first condition may comprise when V_{c} applied to one or more of the battery cells in the second battery 420 is greater than V_{TH}. For example, if the second battery 420 comprises an LFP battery, V_{TH} may be determined from charging profile 520 and may be a function of the temperature of the second battery. Furthermore, if the first battery comprises a PbA battery, V_{c} may be determined from the charging profile 510 and may be a function of the temperature of the first battery. Referring to FIG. 4, plot 500 clearly illustrates that V_{c} given by charging profile 510, is greater than V_{TH} given by charging profile 520, when the temperatures of the first and second battery are less than the threshold temperature 540, T_{TH}. Accordingly, the first condition may further comprise when one or both of the temperatures T₁ and T₂ are less than a threshold temperature T_{TH}.

In response to V_{c} being greater than V_{TH} (or when the first condition is met at 850), then the controller continues at 852, where a portion of the V_{c} in excess of V_{TH} is diverted from the second battery to the one or more external heaters 620. At 852, the controller may actuate one or more switching circuit components (e.g., switch or relay 474) to aid in diverting the excess voltage from all battery cells in the second battery subject to V_{c}>V_{TH}. Furthermore, the controller may divert a portion of the V_{c} in excess of V_{TH} from all the battery cells of the second battery to the one or more external heaters 620 in response to V_{c} being greater than V_{TH} (or when the first condition is met at 850), without diverting any voltage from the battery cells of the first battery.

Next, at 854, heat may be generated at the external heaters from the portion of V_{c} in excess of V_{TH} diverted thereto from the second battery. Since the external heaters 620 are positioned adjacent and external to the battery cells of the second battery, the generated heat may be transferred to the battery cells of the second battery at 856, thereby increasing T₂; and at 858, the controller may adjust V_{TH} based on the new value of T₂. Accordingly, for the case where the second battery comprises an LFP battery, and where V_{TH} is determined based on the charging profile 520, V_{TH} will increase in response to diverting excess voltage to the external heaters, since the charging voltage increases with increasing temperature. Consequently, diverting the charge voltage V_{c} applied to the second battery in excess of V_{TH} may reduce a risk of degradation of the second battery since overcharging the battery is reduced. Furthermore, diverting the charge voltage V_{c} applied to the second battery in excess of V_{TH} may increase a charging performance of the second battery since T₂ is increased, thereby increasing V_{TH}, and the voltage at which all battery cells of the second battery can be charged.

After 850 for the case where V_{c}<V_{TH}, method 800 continues at 860 where the controller applies V_{c} to the second battery without diverting any portion thereof therefrom. Since V_{c}<V_{TH}, V_{c} can be applied to all the battery cells of the second battery without increasing a risk of battery degradation. After 860, and following 858 method 800 continues at 870 where the controller applies V_{c} to the first battery without diverting voltage to the external heaters. As described above, the controller may actuate one or more switching circuitry components to direct V_{c} to the first battery and the second battery in steps 860 and 870 respectively, without diverting any voltage to the external heater. After 870, method 800 ends.

As described above, method 800 may be executed by the controller independently of balancing mode operations, as described with reference to FIG. 6. Furthermore, in method 800, the portion of V_{c} in excess of V_{TH} is diverted for all the battery cells of the second battery where V_{c}>V_{TH}. In this way the method 800 is distinct from the balancing operations of FIG. 6 because the balancing operations divert voltage from individual battery cells based on the state of charge or remaining battery capacity. Furthermore, the steps of method 800 are executed by the controller independently of battery capacity. As such, the steps of method 800 may be executed when the battery capacity of the second battery is higher than a threshold battery capacity, and when the battery capacity of the second battery is lower than a threshold batter capacity.

In this manner, a method for a battery system may include applying a charge voltage to first battery and a second battery electrically connected in parallel, diverting a portion of the charge voltage in excess of a threshold voltage from all battery cells of the second battery to a heater coupled externally to the second battery, and transferring heat from the heater to the second battery, the heat generated from the portion of the charge voltage. In a first example of the method, in the absence of diverting the portion of the charge voltage in excess of the threshold voltage from all battery cells of the second battery to the heater, degradation of an electrode in the second battery would occur upon applying the charge voltage to the second battery. A second example of the method includes the first example and further includes, wherein the portion of the charge voltage in excess of the threshold voltage may be diverted from all battery cells of the second battery to the heater independently of a charge capacity of the second battery. A third example of the method includes one or more of the first and second examples and further includes, wherein the portion of the charge voltage in excess of the threshold voltage may be diverted from the second battery to the heater independently from balancing voltages of the plurality of battery cells of the second battery. A fourth example of the method includes one or more of the first through third examples and further includes generating heat at the heater resulting from diverting the portion of the charge voltage in excess of the threshold voltage from the second battery to the heater, and transferring the heat from the heater to the second battery, thereby raising a temperature of the second battery. A fifth example of the method includes one or more of the first through fourth examples and further includes raising the threshold voltage in response to an increase in the temperature of the second battery. A sixth example of the method includes one or more of the first through fifth examples and further includes lowering the charge voltage in response to an increase in a temperature of the first battery.

In this manner, a method for a battery system may include connecting a first battery and a second battery in parallel, coupling a heater externally to a plurality of battery cells of the second battery, and applying a charge voltage to the first battery and the second battery. During a first condition, comprising when the charge voltage is greater than a threshold voltage, the method may include diverting a portion of the charge voltage in excess of the threshold voltage from the second battery to the heater, and applying the charge voltage to the first battery without diversion of any portion of the charge voltage away from the first battery. In a first example of the method, coupling the heater to the second battery may include positioning the heater directly adjacent but external to the plurality of battery cells of the second battery. A second example of the method optionally includes the first example and further includes wherein diverting the portion of the charge voltage in excess of the threshold voltage is further in response to when a temperature of the second battery is less than a threshold temperature. A third example of the method optionally includes the first and second examples and further includes, wherein diverting the portion of the charge voltage in excess of the threshold voltage may be performed independently from balancing voltages of the plurality of battery cells of the second battery. A fourth example of the method optionally includes the first through third examples and further includes, connecting a generator in parallel to the first battery and the second battery, and generating the charge voltage from the generator.

Turning now to FIG. 8, it illustrates an example timeline 900 illustrating operation of a dual battery system 400 according to method 800. Timeline 900 includes trend lines for V_{c} 910, V_{TH} 912, the effective charging voltage for the first battery, V_{c1} 918, the effective charging voltage for the second battery, V_{c2} 916, T₁ 920, T₂ 926, and a balancing mode status 950. Also shown is the threshold temperature, T_{TH} 922. As described above the charge voltage V_{c} applied to the first battery and the second battery may be determined from the charging voltage profile of the first battery. For example, for the case when the first battery comprises a PbA battery, V_{c} can be determined from a charging profile such as the charging profile 510. The times t1, t2, and t3, may correspond to discrete instances in time when the controller receives transmitted data from various battery system temperature and voltage sensors and when calculated values such as T_{TH} and V_{c} may be determined.

Prior to time t1, both T₁ and T₂ are less than T_{TH}. As described above, T_{TH} may correspond to a threshold temperature 540, below which a charging voltage V_{c} applied to the first and second batteries is greater than V_{TH}. V_{TH} may be determined from a charging profile of the second battery. For the case where the second battery comprises a LFP battery, V_{TH} may be determined based on the charging profile 520 and T₂. Responsive to V_{c}>V_{TH}, the controller diverts the portion of V_{c} in excess of V_{TH} from the second battery to the external heaters, thereby generating heat at the external heaters. Because the voltage in excess of V_{TH} is diverted from the second battery to the heater, the effective charge voltage applied to the second battery, V_{c2} 916, matches V_{TH} 912 (in FIG. 8, V_{c2} 916 and V_{TH} 912 are slightly staggered on the voltage access for illustrative purposes). Furthermore, because the voltage in excess of V_{TH} is diverted from the second battery to the heater without diverting any voltage from the first battery, the effective charge voltage applied to the first battery, V_{c1} 918, matches V_{c} 910 (in FIG. 8, V_{c1} and V_{c} are slightly staggered on the voltage access for illustrative purposes). Because the external heaters are positioned adjacent and external to the battery cells of the second battery, the generated heat is transferred to the battery cells of the second battery and T₂ 926 is increased. Prior to time t1, T₁ also increases gradually because the charging process for the PbA battery is exothermic.

At time t1, owing to the increase in T₂, V_{TH} 912 increases, and owing to the increase in T₁, V_{c} 910 decreases. However, because V_{c} remains greater than V_{TH} between time t1 and time t2, a first condition is met and the controller, in response, continues to divert a portion of the voltage V_{c} in excess of V_{TH} from the second battery, to reduce a risk of degradation of the second battery. As such, heat is generated in the external heaters adjacent to and external to the battery cells of the second battery, thereby increasing T₂ between time t1 and time t2. T₁ also increases gradually between time t1 and time t2 because the charging process for the PbA battery is exothermic. Because the voltage in excess of V_{TH} is diverted from the second battery to the heater, the effective charge voltage applied to the second battery, V_{c2} 916, matches V_{TH} 912; furthermore, because the voltage in excess of V_{TH} is diverted from the second battery to the heater without diverting any voltage from the first battery, the effective charge voltage applied to the first battery, V_{c1} 918, matches V_{c} 910.

Owing to the increase in T₁ 920, V_{c} 910 decreases at time t2. Similarly, owing to the increase in T₂, V_{TH} 912 increases at time t2. At time t2, T₂ increases above T_{TH}, however T₁ still remains below T_{TH}. Timeline 900 uses the example case where T_{TH} corresponds to the threshold temperature 540, and the charging voltage profile of the first battery and the charging voltage profile of the second battery are as given by 510 and 520, respectively, in FIG. 4. At time t2, V_{c}>V_{TH} since the charging voltage of the second battery reaches a cold temperature lithium plating voltage 530 at temperatures greater than T_{TH}, whereas the charging voltage of the first battery is greater than the cold temperature lithium plating voltage 530 at T₁<T_{TH}. Responsive to V_{c}>V_{TH}, upon applying V_{c} to the first and second batteries, the controller diverts a portion of V_{c} in excess of V_{TH} from the second battery to the external heater, to reduce a risk of degradation of the second battery, without diverting any voltage from the first battery. Accordingly between time t2 and time t3, the effective charge voltage to the first battery V_{c1} 918 is equal to the applied charge voltage V_{c}, and the effective charge voltage to the second battery V_{c2} 916 is equal to the threshold voltage V_{TH} 912.

At time t3, T₁ 920 has increased above T_{TH}. Referring to the example case of FIG. 4, when both the temperatures of the first battery and the temperature of the second battery are greater than T_{TH}, the charge voltage for the second battery 520 becomes greater than the charge voltage for the first battery 510. Consequently, at time t3, the applied charging voltage V_{c} 910 to the first and second batteries matches the voltage charging profile for the second battery 520. Accordingly, after time t3, V_{c} 910 matches V_{TH} 912. Furthermore, since V_{c}=V_{TH}, the first condition is not satisfied. In response, the controller does not divert any voltage from the second battery, and does not divert any voltage from the first battery. Thus, the effective applied voltage to the second battery 916 also matches V_{c} 910 and V_{TH} 912 after time t3. Since T₁ and T₂ are both greater than T_{TH}, the effective applied voltage to the first battery V_{c1} 918 matches the charge voltage according to the charging profile for the first battery 510, dropping to a value below V_{c}, V_{TH}, and V_{c2}. As shown from timeline 900, the steps of method 800 may be conducted independently of the balancing mode status 950. In other words, method 800 may be executed while a balancing mode is active or while a balancing mode is inactive.

In this manner, a battery system may include a first battery and a second battery electrically connected in parallel, the second battery comprising a plurality of battery cells and a heater thermally coupled to the plurality of battery cells, and a controller on board the second battery, including executable instructions to, in response to a charge voltage being greater than a threshold voltage, diverting a portion of the charge voltage in excess of a threshold voltage from the second battery to the heater. In a first example of the battery system, the executable instructions may include determining the threshold voltage based on a temperature of the second battery. A second example of the battery system optionally includes the first example and further includes, wherein the executable instructions may include determining the charge voltage based on a temperature of the first battery. A third example of the battery system optionally includes one or more of the first and second examples and further includes, wherein the executable instructions may include raising the threshold voltage in response to an increase in the temperature of the second battery. A fourth example of the battery system optionally includes one or more of the first through third examples and further includes, wherein the executable instructions may include lowering the charge voltage in response to an increase in the temperature of the first battery. A fifth example of the battery system optionally includes one or more of the first through fourth examples and further includes, wherein the heater may be positioned external to the plurality of battery cells and apart from an electrolyte of the second battery. A sixth example of the battery system optionally includes one or more of the first through fifth examples and further includes, wherein the first battery comprises a lead acid battery and the second battery comprises a battery other than a lead acid battery. A seventh example of the battery system optionally includes one or more of the first through sixth examples and further includes, wherein the second battery comprises a lithium iron phosphate battery.

In this way, the technical effect of reducing degradation of the second battery due to high charge voltages can be achieved by diverting voltage from the second battery to a heater thermally coupled to one or more battery cells of the second battery when the applied charge voltage is greater than a threshold voltage, especially at colder temperatures. Furthermore, diverting voltage to the heater can aid in increasing the temperature of the second battery, further increasing performance of the second battery. Further still, reducing degradation of the second battery, including at colder temperatures, facilitates utilizing lower-cost higher-density lithium battery chemistries, such as lithium iron phosphate (LFP), the dual battery system. Further still, the methods and systems described herein may be executed independently of battery capacity and independently from battery charge balancing. Further still, the methods and systems described herein may be applied to heterogeneous dual battery systems comprising batteries of different chemistries, especially batteries having mismatched charging voltage temperature profiles, such as when a charging profile of a first battery monotonically decreases with temperature and while a charging profile for a second battery monotonically increases with temperature. Further still, the systems and methods may be applied to existing dual battery systems relatively inexpensively by retrofitting the second battery with one or more external heaters positioned adjacent and external to the battery cells of the second battery.

The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1-15. (canceled)

16. A method for a battery system, the method comprising:
applying a charge voltage to a first battery and a second battery electrically connected in parallel;
diverting a portion of the charge voltage in excess of a threshold voltage from all of a plurality of battery cells of the second battery to a heater coupled externally to the second battery; and
transferring heat from the heater to the second battery, the heat generated from the portion of the charge voltage.

17. The method of claim 16, wherein in an absence of diverting the portion of the charge voltage in excess of the threshold voltage from all of the plurality of battery cells of the second battery to the heater, degradation of an electrode in the second battery would occur upon applying the charge voltage to the second battery.

18. The method of claim 16, wherein the portion of the charge voltage in excess of the threshold voltage is diverted from all of the plurality of battery cells of the second battery to the heater independently of a charge capacity of the second battery.

19. The method of claim 16, wherein the portion of the charge voltage in excess of the threshold voltage is diverted from the second battery to the heater independently from balancing voltages of the plurality of battery cells of the second battery.

20. The method of claim 16, further comprising:
generating heat at the heater resulting from diverting the portion of the charge voltage in excess of the threshold voltage from the second battery to the heater; and
transferring the heat from the heater to the second battery, thereby raising a temperature of the second battery.

21. The method of claim 16, further comprising raising the threshold voltage in response to an increase in a temperature of the second battery.

22. The method of claim 21, further comprising lowering the charge voltage in response to an increase in a temperature of the first battery.

23. A battery system, comprising:
a first battery and a second battery electrically connected in parallel, the second battery comprising a plurality of battery cells and a heater thermally coupled to the plurality of battery cells; and
a controller on board the second battery, including executable instructions to,
in response to a charge voltage being greater than a threshold voltage, diverting a portion of the charge voltage in excess of the threshold voltage from the second battery to the heater.

24. The battery system of claim 23, wherein the executable instructions further comprise determining the threshold voltage based on a temperature of the second battery.

25. The battery system of claim 24, wherein the executable instructions further comprise determining the charge voltage based on a temperature of the first battery.

26. The battery system of claim 25, wherein the executable instructions further comprise raising the threshold voltage in response to an increase in the temperature of the second battery.

27. The battery system of claim 26, wherein the executable instructions further comprise lowering the charge voltage in response to an increase in the temperature of the first battery.

28. The battery system of claim 27, wherein the heater is positioned external to the plurality of battery cells and apart from an electrolyte of the second battery.

29. The battery system of claim 28, wherein the first battery comprises a lead acid battery and the second battery comprises a battery other than a lead acid battery.

30. The battery system of claim 29, wherein the second battery comprises a lithium iron phosphate battery.

31. A method for a battery system, the method comprising:
connecting a first battery and a second battery in parallel;
coupling a heater externally to a plurality of battery cells of the second battery;
applying a charge voltage to the first battery and the second battery; and
when the charge voltage is greater than a threshold voltage,
diverting a portion of the charge voltage in excess of the threshold voltage from the second battery to the heater, and
applying the charge voltage to the first battery without diversion of any remaining portion of the charge voltage away from the first battery.

32. The method of claim 31, wherein coupling the heater to the second battery comprises positioning the heater directly adjacent but external to the plurality of battery cells of the second battery.

33. The method of claim 32, wherein diverting the portion of the charge voltage in excess of the threshold voltage is further in response to when a temperature of the second battery is less than a threshold temperature.

34. The method of claim 33, wherein diverting the portion of the charge voltage in excess of the threshold voltage is performed independently from balancing voltages of the plurality of battery cells of the second battery.

35. The method of claim 34, further comprising connecting a generator in parallel to the first battery and the second battery, and generating the charge voltage from the generator.
